(19) United States
(12) Patent Application Publication
(10) Pub. No.: US 2017/0191507 A1
(43) Pub. Date: Jul. 6, 2017

(54) FLUID-OPERATED LINEAR ACTUATOR

(71) Applicant: AIR TORQUE S.P.A., Costa Di Mezzate (IT)

(72) Inventors: Antonio MARINONI, Grumello Del Monte (IT); Santo ROTA, Albano Sant'alessandro (IT); Ignazio PARIS, Grumello Del Monte (IT)

(21) Appl. No.: 15/315,294

(22) PCT Filed: May 29, 2015
(86) PCT No.: PCT/IB2015/054071

§ 371 Date: Nov. 30, 2016

(30) Foreign Application Priority Data
May 30, 2014 (IT) MI2014A001001

(51) Int. Cl. F15B 15/14; F15B 15/02

(52) U.S. Cl. CPC F15B 15/14; F15B 15/02

(57) ABSTRACT

A fluid-operated linear actuator includes a tubular body, a pair of heads, at least one head of the pair of heads is perforated, at least one piston and at least one stem which passes through the at least one perforated head. The pair of heads are locked at the ends of the tubular body by way of retention rings which are integral with the tubular body and are arranged proximate to the ends on the inner surface of the tubular body. The heads are fixed integrally to the retention rings by way of a connection component.

### CROSS-REFERENCE TO RELATED APPLICATIONS

This application is related to and claims the benefit of Italian Patent Application No. MI2014A001001, filed on May 30, 2014, the contents of which are herein incorporated by reference in their entirety.

### TECHNICAL FIELD

The present disclosure relates to a fluid-operated linear actuator, which is particularly, although not exclusively, useful and practical for moving machines and devices in the area of industrial automation.

### BACKGROUND

Currently there are various types of fluid-operated linear actuators, commonly known as fluid cylinders, both single-acting and double-acting, which are used to convert the pressure of a fluid inside them to a force of thrust and/or traction, such force being used directly for movement or being converted to rotary force by way of adapted mechanisms, such as, for example, a mechanism provided with slotted links.

Typical examples of conventional fluid cylinders, which are also the most common examples and which most often find application at the industrial level, are hydraulic fluid-actuated cylinders, if the fluid in the cylinder is a liquid (generally hydraulic oil), and pneumatically-actuated cylinders, if the fluid in the cylinder is a gas (generally compressed air).

The main elements that make up such conventional fluid cylinders are a tubular body, which ends with two heads, and a piston with a stem. At least one of the heads must be perforated in order to allow the passage of the stem of the piston.

In particular, in conventional fluid cylinders, the heads arranged at the ends of the tubular body are usually fixed and locked to it by way of tie rods. A tie rod is constituted by a bar, threaded along its entire length or threaded only at its ends, such bar being of a suitable length, i.e. a few centimeters longer than the length of the tubular body, and provided with two nuts.

The tie rod is thus the solution most often used in removable rigid couplings for joining the tubular body with the heads, which substancially perform the function of flanges. In essence, the tubular body is enclosed between the heads as if the latter were in fact flanges, and they are then connected and rigidly coupled to each other by way of the tie rods and the nuts screwed onto the ends of such tie rods.

Conventional fluid-operated linear actuators are not devoid of drawbacks, among which is the fact that the presence of the tie rods makes the assembly of fluid cylinders more complex and laborious, in particular with regard to the alignment between the heads arranged at the ends of the tubular body and said tubular body itself, and between the peripheral holes of such heads for the passage of the tie rods.

Another drawback of such conventional fluid-operated linear actuators consists in that they can suffer from structural problems deriving from the elongation of the tie rods, such elongation occurring in the event of great variations of temperature, putting the mechanical strength and the hermetic seal of such conventional fluid cylinders at risk.

A further drawback of such conventional fluid-operated linear actuators consists in that the presence of the tie rods makes the shape structure, and in particular the outer surface, of the fluid cylinders irregular, causing difficulties with any painting and/or covering thereof, the latter being particularly useful for the protection of the fluid cylinders if these are used in outside environments, and thus are subjected to atmospheric agents, or in environments that have a high density of foreign items, such as, for example, dust or machining residues.

The aim of the present disclosure is to overcome the limitations of the known art described above, by devising a fluid-operated linear actuator that makes it possible to obtain similar or better effects with respect to those that can be obtained with conventional fluid-operated linear actuators, while further enabling a correct assembly of the fluid cylinder proper without the use of tie rods, and also ensuring a sufficient mechanical strength and an adapted hermetic seal.

### SUMMARY

Within this aim, the present disclosure devises a fluid-operated linear actuator that can be assembled easily and rapidly, while still ensuring a sufficient mechanical strength and an adapted hermetic seal.

The present disclosure also provides a fluid-operated linear actuator that does not suffer from structural problems deriving from the elongation of the tie rods, such elongation occurring in conventional fluid cylinders in the event of great variations of temperature, putting the mechanical strength and the hermetic seal of such conventional fluid cylinders at risk.

The present disclosure provides a fluid-operated linear actuator that makes it possible, thanks to its shape structure, to carry out the complete painting and/or covering of the outer surface of the fluid cylinder, in order to protect fluid cylinders used in outside environments or in environments that have a high density of foreign items.

The present disclosure further devises a fluid-operated linear actuator that has a smaller total volume with respect to conventional fluid cylinders which have the same capacity.

The present disclosure further provides a fluid-operated linear actuator that is highly reliable, easily and practically implemented and low cost.

These aims and advantages which will become better apparent hereinafter are achieved by providing a fluid-operated linear actuator, comprising a tubular body, a pair of heads, at least one of which is perforated, at least one piston and at least one stem which passes through said at least one perforated head, wherein said heads are locked at the ends of said tubular body by way of retention rings which are integral with said tubular body and are arranged proximate to said ends on the inner surface of said tubular body, said heads being fixed integrally to said retention rings by way of connection means.

### BRIEF DESCRIPTION OF THE DRAWINGS

Further characteristics and advantages of the disclosure will become better apparent from the description of a preferred, but not exclusive, embodiment of the fluid-operated linear actuator according to the disclosure, which is illustrated by way of non-limiting example in the accompanying drawings wherein:

FIG. 1 is a perspective view of an embodiment of a fluid-operated linear actuator according to the present disclosure;

FIGS. 2a and 2b are cutaway perspective views of an embodiment of the fluid-operated linear actuator according to the present disclosure;

FIG. 3 is a detailed view of the fixing of the front head to the tubular body of an embodiment of the fluid-operated linear actuator according to the present disclosure; and

FIG. 4 is a detailed view of the fixing of the rear head to the tubular body of an embodiment of the fluid-operated linear actuator according to the present disclosure.

### DETAILED DESCRIPTION OF THE DRAWINGS

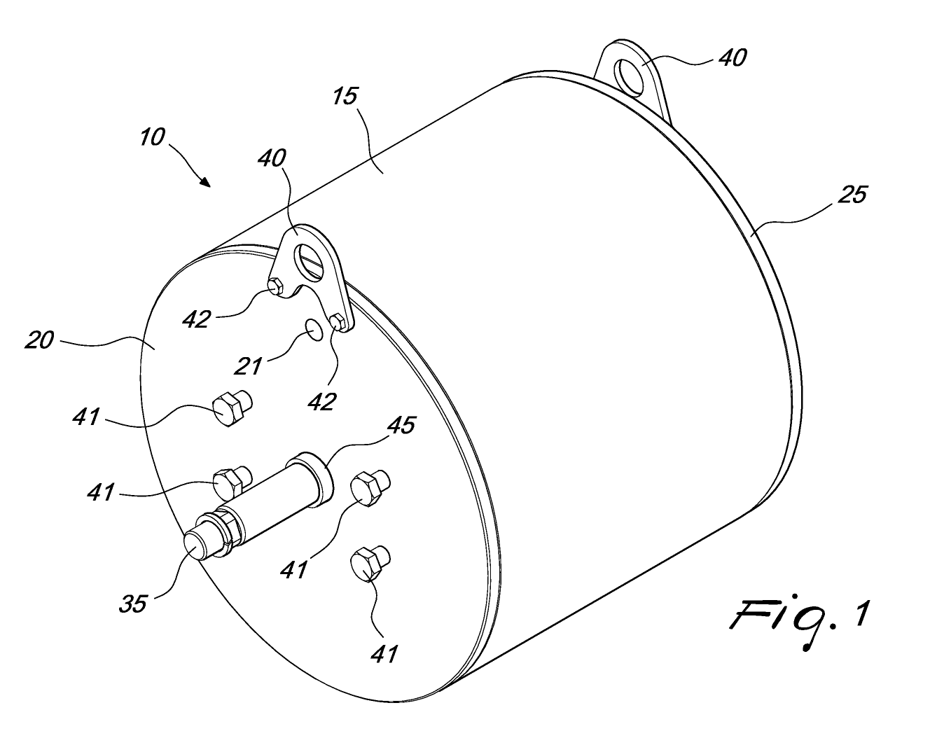

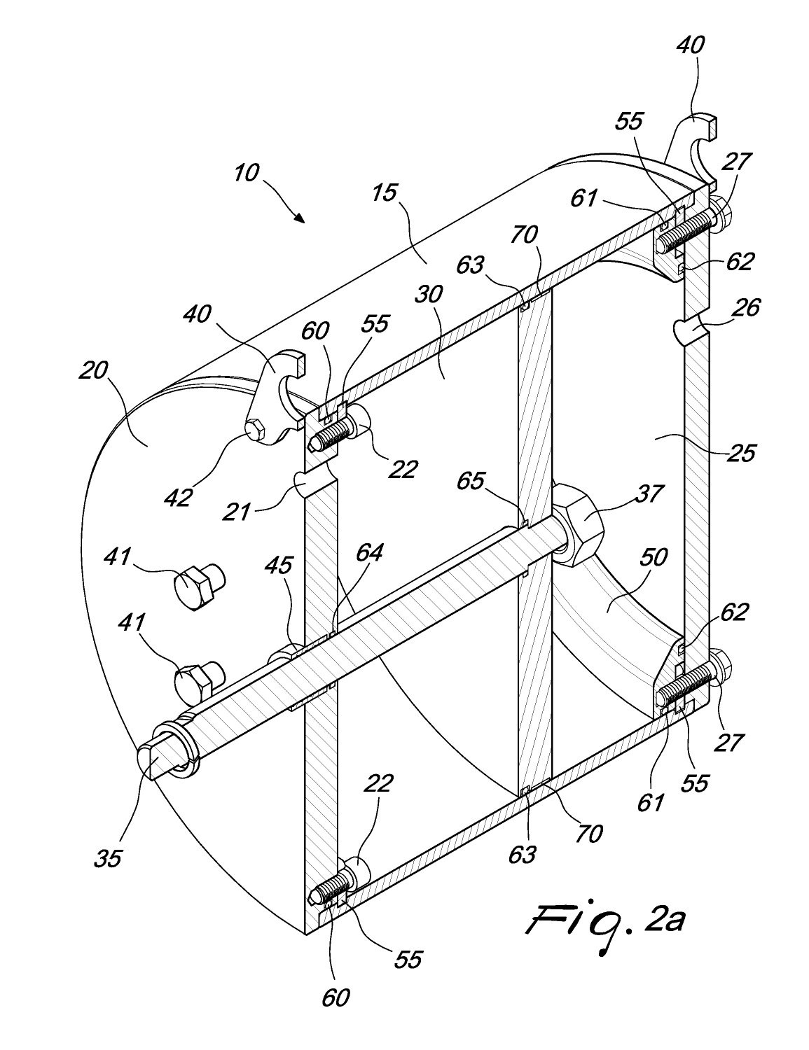

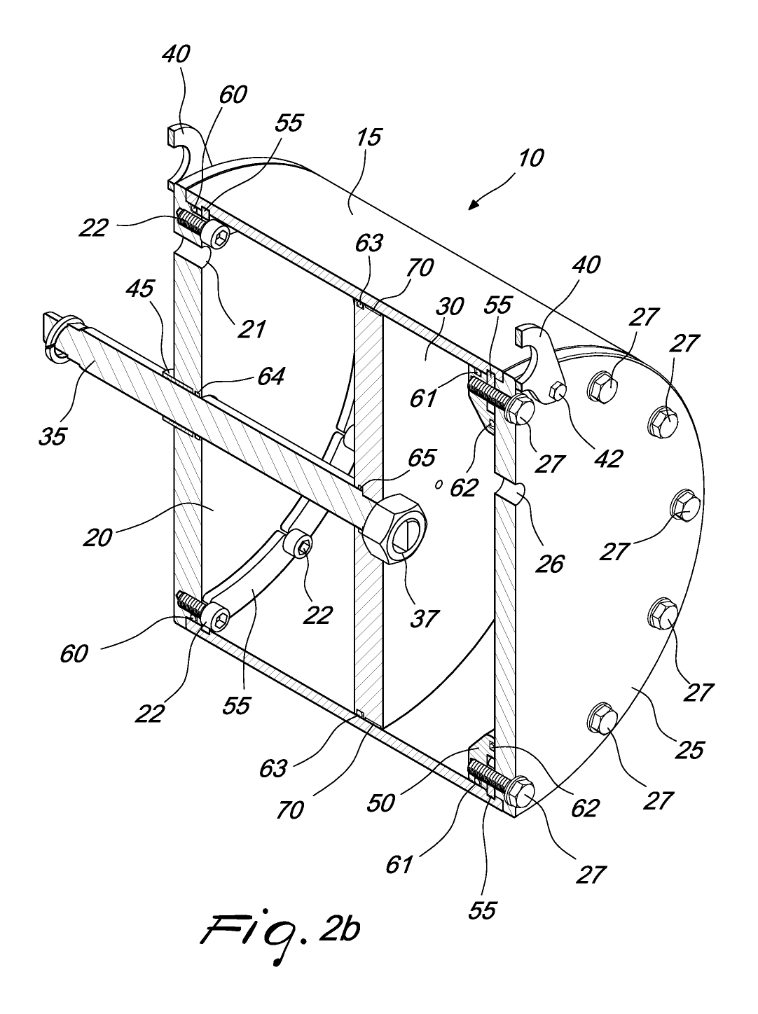

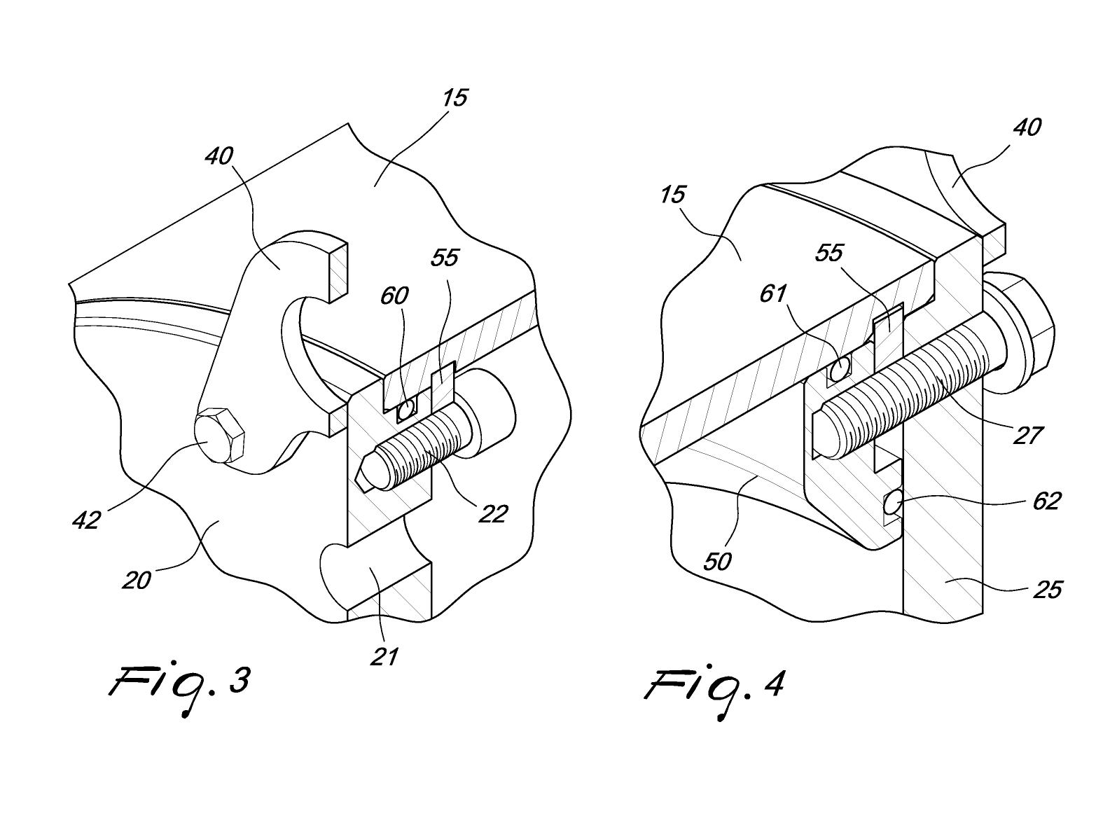

With reference to FIG. 1a-FIG. 4, the fluid-operated linear actuator according to the disclosure, generally designated by the reference numeral 10, substantially comprises a tubular body 15, a front head 20 and a rear head 25 which are fixed to the ends of the tubular body 15, a piston 30 placed inside the tubular body 15, and a stem 35, the latter fixed to the piston 30 and passing through a hole in the center of the front head 20.

The tubular body 15 is preferably made of metallic material, such as, for example, steel or aluminum, has a hollow cylindrical shape and is, in essence, the element that constitutes the supporting structure of the linear actuator 10 and which defines its dimensions; such dimensions, and in particular the inside diameter and the length of the tubular body 15, dictate the volume of fluid under pressure which the linear actuator 10 is capable of handling and, as a consequence, also dictate the force that the linear actuator 10 is capable of exerting.

The tubular body 15 comprises a pair of retention rings 55, which are also preferably made of metallic material, and are positioned proximate to the ends of the tubular body 15, along the circumference of the inner surface of the tubular body 15.

In a different embodiment of the disclosure, each retention ring 55 can also be made up of a plurality of mutually separate sectors, by way of example 2, 3 or 4 sectors, which still constitute a substantially complete circumference once they are brought together.

The retention rings 55 have an inside diameter and outside diameter which respectively are smaller and larger than the inside diameter of the tubular body 15, the retention rings 55 thus being integral with the tubular body 15 and adapted to create a kind of protrusion along the circumference of the inner surface of the tubular body 15.

Fixed to the ends of the tubular body 15 are a front head 20 and a rear head 25, both preferably made of metallic material, such as, for example, steel or aluminum, and both having a flat and circular shape with a diameter such that their outer rim corresponds to the edge of the ends of the tubular body 15. In addition to the structural functions, the heads 20 and 25 also have the function of stopping the movement of the load, by acting as the mechanical stroke limiting abutment.

The front head 20 has a hole in its center for the passage of the stem 35, which will be described below, and arranged at such hole are a guide bushing 45, which is preferably made of bronze, and adapted sealing means 64, such as, for example, a gasket made of nitrile rubber, the latter in order to prevent the leakage, i.e. the flow, of the fluid through the fissure present between the central hole of the front head 20 and the stem 35.

The front head 20 also has a hole 21 which is adapted to allow the movement, during the operation of the linear actuator 10, of the fluid present inside the tubular body 15; such hole constitutes, in essence, the connector for the conduit of the fluid, such fluid being, for example, hydraulic oil, for hydraulic fluid-actuated cylinders, or compressed air, for pneumatically-actuated cylinders.

The front head 20 further comprises means for the movement of the linear actuator 10 and means for the fixing thereof to the supports present on the machine for which it is intended, since, in order to be capable of developing the required force, the linear actuator 10 must be fixed to the machine in a suitable manner Such means for movement of the linear actuator 10 can be constituted, for example, by an eyelet 40, which is connected to the front head 20 by way of screws 42 or by way of welding. Such means for fixing the linear actuator 10, on the other hand, can be constituted, for example, by screws 41 arranged on the outer surface of the front head 20.

The front head 20 is locked to one end of the tubular body 15 thanks to the impediment offered by the corresponding retention ring 55, to which it is fixed integrally by way of connection means 22, such as, for example, screws, preferably cylindrical head screws with hex sockets, which are screwed from inside the tubular body 15 into adapted threaded holes, the latter being present along the circular edge of the inner surface of the front head 20 and being shorter than the thickness of the front head 20.

In order to prevent the leakage, i.e. the flow, of the fluid through the join between the tubular body 15 and the front head 20, the front head 20 comprises sealing means 60, such as, for example, an O-ring gasket made of nitrile rubber, which is placed in contact with the inner surface of the tubular body 15.

Similarly to the front head 20, the rear head 25 also has a hole 26 which is adapted to allow the movement, during the operation of the linear actuator 10, of the fluid present inside the tubular body 15; such hole constitutes, in essence, the connector for the conduit of the fluid, such fluid being, for example, hydraulic oil, for hydraulic fluid-actuated cylinders, or compressed air, for pneumatically-actuated cylinders.

The rear head 25 further comprises means for the movement of the linear actuator 10, which are added to the means for its movement which are comprised in the front head 20. Such means for movement of the linear actuator 10 can be constituted, for example, by an eyelet 40, which is connected to the rear head 25 by way of screws 42 or by way of welding.

The rear head 25 is locked to the other end of the tubular body 15 thanks to the impediment offered by the corresponding retention ring 55, to which it is fixed integrally by way of a backing ring 50 and connection means 27, such as, for example, screws, preferably hex head screws, which are screwed from outside the tubular body 15 into adapted threaded holes which are present along the backing ring 50, first passing through the rear head 25.

In order to prevent the leakage, i.e. the flow, of the fluid through the join between the tubular body 15 and the front head 20, the backing ring 50 comprises, in addition to the threaded holes for the screws 27 mentioned above, sealing means 61 and 62, such as, for example, O-ring gaskets made of nitrile rubber, the first 61 arranged in contact with the inner surface of the tubular body 15 and the second 62 arranged in contact with the inner surface of the rear head 25.

The piston 30, which is preferably made of metallic material, such as, for example, steel or aluminum, is arranged inside the tubular body 15, at right angles to the longitudinal axis of the tubular body 15, and has a flat and circular shape with a diameter such that its outer rim corresponds to the inner surface of the tubular body 15.

The piston 30 comprises, along its outer rim and in contact with the inner surface of the tubular body 15, anti-friction means 70 and adapted sealing means 63, such as, for example, a gasket made of nitrile rubber, the latter in order to prevent the passage, i.e. the flow, of the fluid from one side to the other of the piston 30, i.e. from one chamber to the other, through the fissure present between the inner surface of the tubular body 15 and the outer rim of the piston 30.

The piston 30 is further provided with a central hole for the fixing of the stem 35, at such hole adapted sealing means 65 being arranged, such as, for example, an O-ring gasket made of nitrile rubber, the latter also in order to prevent the passage, i.e. the flow, of the fluid from one side to the other of the piston 30, i.e. from one chamber to the other, in this case through the fissure present between the central hole of the piston 30 and the stem 35.

The stem 35 is a simple stem and is constituted by a bar which is preferably made of metallic material, such as, for example, steel or aluminum; one of the ends of the stem 35 is inserted in the central hole of the piston 30 and is fixed to the latter thanks to connection means 37, such as, for example, a nut screwed onto an adapted threading, such end being directed toward the inner surface of the rear head 25.

In an embodiment, it is possible to apply, on the rear head 25, a pin, a screw or even a mechanism that, by acting on the end of the stem 35 where the nut 37 is screwed, acts as a stroke limiter, a device for the modulation of the sliding speed of the piston 30, or even means for an emergency manipulation, in the event of absence of the fluid under pressure.

The stem 35 passes further through the hole present in the center of the front head 20, and arranged at such hole are, as mentioned, a bushing 45 for guiding the stem 35 and adapted sealing means 64, the latter in order to prevent the leakage, i.e. the flow, of the fluid through the fissure present between the central hole of the front head 20 and the stem 35 itself

In a different embodiment of the disclosure, the heads 20 and 25 of the fluid-operated linear actuator 10 can both be perforated in the center, in order to allow the use of a stem 35 of the pass-through or double-ended type, which is very useful for lateral loads applied to the stem 35.

In practice it has been found that the disclosure fully achieves the set aims and advantages. In particular, it has been seen that the fluid-operated linear actuator thus conceived makes it possible to overcome the limitations of the known art, in that it enables a correct assembly of the fluid cylinder itself without the use of tie rods, while also ensuring a sufficient mechanical strength and an adapted hermetic seal.

Although the fluid-operated linear actuator according to the disclosure has been devised in particular for moving machines and devices in the area of industrial automation, it can also be used, more generally, in any context in which the execution is necessary of a linear movement of the mechanical type.

The disclosure, thus conceived, is susceptible of numerous modifications and variations, all of which are within the scope of the appended claims; by way of non-limiting example, the person skilled in the art will understand without effort that a return spring can be provided if the fluid-operated linear actuator is of the single-acting type, or the piston can be of the plunger type. Moreover, all the details may be substituted by other, technically equivalent elements.

In practice the materials employed, and the contingent dimensions and shapes, may be any according to requirements and to the state of the art.

1.-10. (canceled)

11. A fluid-operated linear actuator, comprising a tubular body, a pair of heads, at least one head of said pair is perforated, at least one piston and at least one stem which passes through said at least one perforated head, wherein said heads are locked at ends of said tubular body by way of retention rings which are integral with said tubular body and are arranged proximate to said ends on the inner surface of said tubular body, said heads being fixed integrally to said retention rings by way of connection means.

12. The fluid-operated linear actuator according to claim 11, wherein at least one of said heads is further fixed to said retention rings by way of a backing ring for said connection means.

13. The fluid-operated linear actuator according to claim 11, wherein at least one of said heads comprises sealing means.

14. The fluid-operated linear actuator according to claim 12, wherein said backing ring comprises sealing means.

15. The fluid-operated linear actuator according to claim 11, wherein said connection means include screws.

16. The fluid-operated linear actuator according to claim 15, wherein said screws are hex head screws or cylindrical head screws with hex sockets.

17. The fluid-operated linear actuator according to claim 12, wherein at least one of said heads and said backing ring comprises threaded holes for screwing said connection means.

18. The fluid-operated linear actuator according to claim 11, wherein at least one of said heads comprises fixing means.

19. The fluid-operated linear actuator according to claim 11, wherein at least one of said heads comprises means for moving said linear actuator.

20. The fluid-operated linear actuator according to claim 19, wherein said means for moving said linear actuator include at least one eyelet.
